(19) United States
(12) Patent Application Publication
(10) Pub. No.: US 2014/0139419 A1
(43) Pub. Date: May 22, 2014

(54) BACKLIGHT DRIVING CIRCUIT, BACKLIGHT MODULE, AND LCD DEVICE

(71) Applicant: SHENZHEN CHINA STAR OPTOELECTRONICS TECHNOLOGY CO., LTD., Shenzhen (CN)

(72) Inventors: Hua Zhang, Shenzhen (CN); Xiang Yang, Shenzhen (CN)

(73) Assignee: SHENZHEN CHINA STAR OPTOELECTRONICS TECHNOLOGY CO. LTD., Shenzhen (CN)

(21) Appl. No.: 13/806,804

(22) PCT Filed: Nov. 23, 2012
(86) PCT No.: PCT/CN12/85115

§ 371 Date: Dec. 24, 2012

(30) Foreign Application Priority Data
Nov. 22, 2012 (CN) 201210478590.X

(51) Int. Cl. G09G 3/34; G09G 3/36

(52) U.S. Cl. CPC G09G 3/3406; G09G 3/36
USPC 345/102

(57) ABSTRACT

A backlight driving circuit includes a power supply module, an inductor connected with an output end of the power supply module, and a light emitting diode (LED) lightbar connected with the inductor in series. A monitoring module detecting an output current of the inductor is coupled between the inductor and the LED lightbar. A controllable switch is connected between an output end of the inductor and a grounding terminal of the backlight driving circuit. The monitoring module is coupled with the controllable switch. When the output current of the inductor is lower than a preset value, the monitoring module controls the controllable switch to turn on.

### TECHNICAL FIELD

The present disclosure relates to the field of liquid crystal displays (LCDs), and more particularly to a backlight driving circuit, a backlight module, and an LCD device.

### BACKGROUND

A liquid crystal display (LCD) device includes an LCD panel and a backlight module providing a light source to the LCD panel. In order to reduce costs associated with light emitting diodes (LEDs), a typical backlight module mostly uses the LEDs as light sources. As shown in FIG. 1, generally, a lightbar made of a plurality of LEDs that are connected in series is used to the backlight module of using the LEDs as the light sources, and a boost circuit is used to drive the lightbar to emit light. An inductor L1 of the boosted circuit is an important component. Under a condition that an LED load is fixed, an inductance value of the inductor L1 determines that the inductor L1 is working in a continuous current mode or a discontinuous current mode. When the inductance value of the inductor being used is less than the inductance value in a critical working mode due to process deviation in making the inductor, the inductor works in the discontinuous current mode. Although the effective current value of the inductor in the discontinuous current mode and the effective current value of the inductor in the continuous current mode are identical, a peak current of the inductor in the discontinuous current mode is greater than a peak current of the inductor in the continuous current mode (as shown in FIG. 2). Thus, some key components of metal-oxide-semiconductor field-effect transistor (MOSFET) Q1 and diode D1 in the circuit need greater bearing capability. Even the key components may be damaged.

### SUMMARY

In view of the above-described problems, the aim of the present disclosure is to provide a backlight driving circuit, a backlight module, and a liquid crystal display (LCD) device capable of protecting devices against being damaged by peak current of an inductor.

The aim of the present disclosure is achieved by the following technical scheme.

A backlight driving circuit comprises a power supply module, an inductor connected with an output end of the power supply module, and an LED lightbar connected with the inductor in series. A monitoring module detecting an output current of the inductor is coupled between the inductor and the LED lightbar. A controllable switch is connected between an output end of the inductor and a grounding terminal of the backlight driving circuit. The monitoring module is coupled with the controllable switch. When the output current of the inductor is lower than a preset value, the monitoring module controls the controllable switch to turn on.

Furthermore, the monitoring module comprises a current detecting unit connected between the inductor and the lightbar in series, and a control unit coupled with the current detecting unit. A control signal of the control unit is coupled to the controllable switch. This is a technical scheme of detecting the output current of the inductor by the current detecting unit. Optionally, a technical scheme of voltage detection is also feasible.

Furthermore, the current detecting unit comprises a transformer. A primary coil of the transformer is connected between the inductor and the lightbar in series. A secondary coil of the transformer is grounded by a divider resistor. A sampling voltage of the divider resistor is coupled to the control unit. Because the primary coil and the secondary coil of the transformer are separated, a main circuit of the primary coil and a sampling circuit of the secondary coil do not disturb each other. If the circuit on either side of the transformer TR1 has any problems, the circuit on the other side is not damaged, and reliability is high. In addition, because current in the secondary coil of the transformer is proportional to current in the primary coil of the transformer, the sampling voltage on two ends of the divider resistor connected with the secondary coil may linearly change along with the current of the primary coil, thus, change of the current is converted into change of voltage, which favoringly controls collection of current data.

Furthermore, the control unit comprises a comparator. A non-inverting input of the comparator is coupled with a reference voltage. The current detecting unit outputs a comparison voltage to an inverting input of the comparator. When the output current of the inductor is lower than the preset value, if the reference voltage is greater than the comparison voltage, the reference voltage becomes less than the comparison voltage, and if the comparison voltage is greater than the reference voltage, then the comparison voltage becomes less than the reference voltage, which enables the comparator to output a control signal to turn on the controllable switch. This is a specific control unit structure. The technical scheme of using the comparator is simple and lower in cost.

Furthermore, when the comparison voltage is lower than the reference voltage, the comparator outputs a high level signal to turn on the controllable switch. This is a specific comparator. When the voltage at the non-inverting input is greater than the voltage at the inverting input, a high level signal is outputted. Optionally, if the controllable switch is conducted by a low level signal, a comparator with contrary logic may be used.

Furthermore, the preset value is zero. if the preset value is zero, the inductor has no output current and the current flowing through the transformer is zero. Thus, the secondary coil has no current, and the sampling voltage is zero. Voltage difference between the sampling voltage and the reference voltage may be further increased. A logical determination of the comparator is more accurate, thus avoiding resulting in misoperation caused by smaller voltage difference.

Furthermore, the preset value is zero. The monitoring module comprises a current detecting unit connected between the inductor and the lightbar in series, and a control unit coupled with the current detecting unit. A control, signal of the control unit is coupled to the controllable switch. The current detecting unit comprises a transformer. A primary coil of the transformer is connected between the inductor and the lightbar in series. A secondary coil of the transformer is grounded by a divider resistor. The control unit comprises a comparator. A non-inverting input of the comparator is coupled with a reference voltage. An output of the comparator is coupled to the controllable switch. A sampling voltage of the divider resistor is coupled to an inverting input of the comparator. When the output current of the inductor is zero, the sampling voltage is lower than the reference voltage. The comparator outputs as high level signal to turn on the controllable switch. This is a specific circuit structure of the monitoring module. Because the primary coil and the secondary coil of the transformer are separated, a main circuit of the primary coil and a sampling circuit of the secondary coil do not disturb each other. If the circuit on either side of the transformer TR1 has any problems, the circuit on the other side is not damaged, and reliability is high. In addition, because current in the secondary coil of the transformer is proportional to current in the primary coil of the transformer, the sampling voltage on two ends of the divider resistor connected with the secondary coil may linearly change along with the current of the primary coil, thus, change of the current is converted into change of voltage, which favoringly controls collection of current data. The technical scheme of using the comparator is simple and lower in cost. When the voltage at the non-inverting input is greater than the voltage at the inverting input, a high level signal is outputted. Optionally, if the controllable switch is conducted by a low level signal, a comparator with contrary logic may be used. If the preset value is zero, the inductor has no output current and the current flowing through the transformer is zero. Thus, the secondary coil has current, and the sampling voltage is zero. Voltage difference between the sampling voltage and the reference voltage may be further increased. A logical determination of the comparator is more accurate, thus avoiding resulting in misoperation caused by smaller voltage difference.

Furthermore, a diode is connected between the inductor and the monitoring module in series. An anode of the diode is coupled to the inductor, and a cathode of the diode is coupled to the monitoring module. A capacitor is connected to two ends of the lightbar in parallel. This is a specific structure of the boost circuit.

A backlight module comprises any backlight driving circuit mentioned above.

An LCD device comprises the backlight module mentioned above.

In the present disclosure, because the circuit is configured with the monitoring module, when the output current of the inductor is lower than the preset value, the monitoring module may control the controllable switch to turn on so as to forcedly ground the output end of the inductor. Thus, an integral conductive loop is formed among the power supply module, the inductor, and the controllable switch. The current still flows through the inductor. The circuit is forced to skip zero crossing current stage and enters the next work cycle of the boosted circuit. The inductor may work in the continuous current mode by regulating duty ratio of the controllable switch, which avoids generating greater peak current, thereby protecting the LCD device, and safety of the circuit is improved. In addition, the peak current of the inductor is reduced so that components with reduced specifications may be used, reducing manufacturing cost.

### BRIEF DESCRIPTION OF FIGURES

FIG. 1 is a schematic diagram of a typical backlight driving circuit;

FIG. 2 is a diagram of a waveform that an inductor is working in a discontinuous current mode and in a continuous current mode;

FIG. 3 is a schematic diagram of an example of the present disclosure; and

FIG. 4 is a schematic diagram of a specific circuit of an example of the present disclosure.

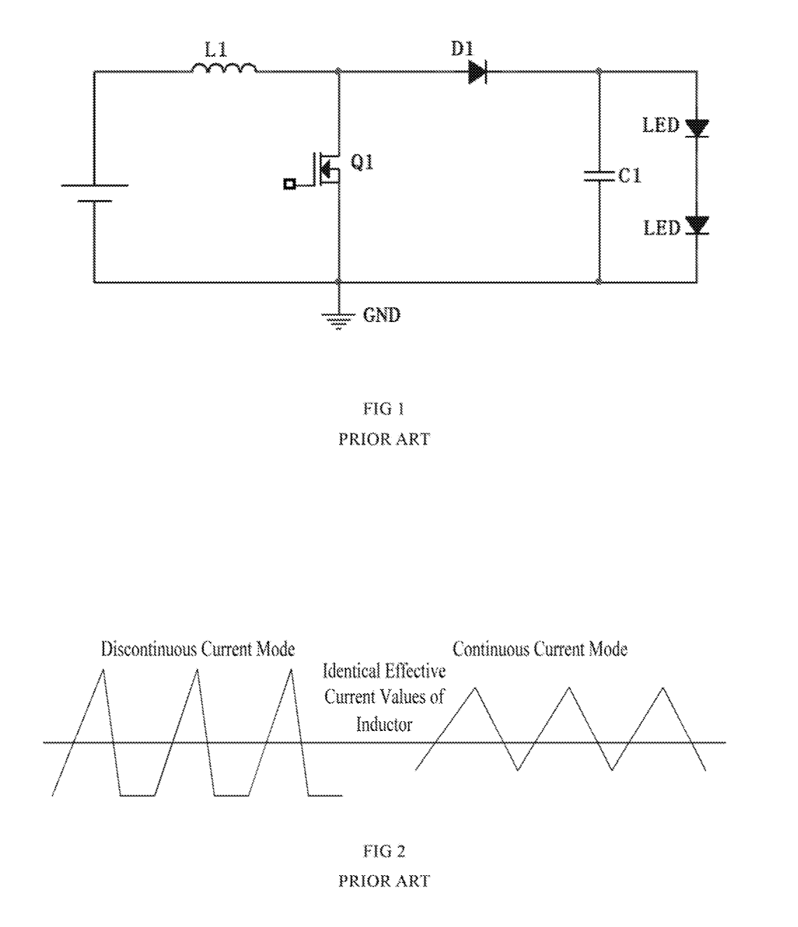

### DETAILED DESCRIPTION

The present disclosure discloses a liquid crystal display (LCD) device. The LCD device comprises an LCD panel and a backlight module providing a light source to the LCD panel. The backlight module comprises a backlight driving circuit. The backlight driving circuit comprises a power supply module, an inductor connected with an output end of the power supply module, and a light emitting diode (LED) lightbar that connects with the inductor in series. A monitoring module detecting an output current of the inductor is coupled between the inductor and the LED lightbar. A controllable switch is connected between an output end of the inductor and a grounding terminal of the backlight driving circuit. The monitoring module is coupled with the controllable switch. When the output current of the inductor is lower than a preset value, the monitoring module controls the controllable switch to turn on.

In the present disclosure, because the circuit is configured with the monitoring module, when the output current of the inductor is lower than the preset value, the monitoring module may control the controllable switch to turn on so as to forcedly ground the output end of the inductor. Thus, an integral conductive loop is formed among the power supply module, the inductor, and the controllable switch. The current still flows through the inductor. The circuit is forced to skip zero crossing current stage and enters a next work cycle of the boosted circuit. The inductor may work in the continuous current mode by regulating, duty ratio of the controllable switch, which avoids generating greater peak current, thereby protecting the LCD device, and safety of the circuit is improved. In addition, the peak current of the inductor is reduced so that components with reduced specifications may be used, reducing manufacturing cost.

The present disclosure is further described in detail in accordance with the figures and the preferable examples.

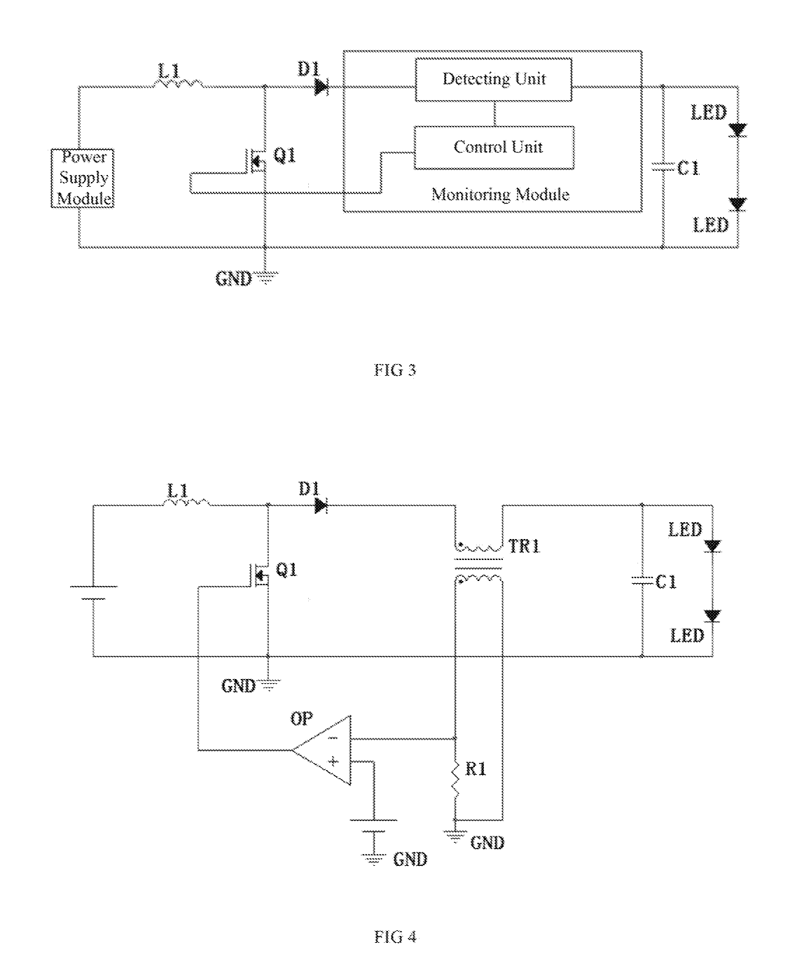

As shown in FIG. 3, the backlight driving circuit in the example comprises a power supply module. An output end of the power supply module is successively connected in series with an inductor L1, a diode D1, a monitoring module, and a lightbar formed by connecting LEDs in series. Thus, an integral main power supply circuit is formed. A controllable, switch Q1 is connected between an output end of the inductor L1 and a grounding terminal of the backlight driving circuit. A capacitor C1 is connected to two ends of the lightbar in parallel. The monitoring module comprises a current detecting unit connected in series between the inductor L1 and the lightbar, and a control unit coupled with the current detecting unit. A control signal of the control unit is coupled to the controllable switch Q1. When the output current of the inductor L1 is lower than the preset value, the monitoring module controls the controllable switch Q1 to turn on.

As shown in FIG. 4, the monitoring module comprises the current detecting unit connected in series between the inductor L1 and the lightbar, and the control unit coupled with the current detecting unit. The control signal of the control unit is coupled to the controllable switch Q1. The current detecting unit comprises a transformer TR1. A primary coil of the transformer TR1 is connected between the inductor L1 and the lightbar in series. A secondary coil of the transformer TR1 is grounded by a divider resistor R1. The control unit comprises a comparator OP. A non-inverting input of the comparator OP is coupled with a reference voltage. An output of the comparator OP is coupled to the controllable switch Q1. A sampling voltage of the divider resistor R1 is coupled to an inverting input of the comparator OP. When the output current of the inductor L1 is zero, the sampling voltage is lower than the reference voltage. The comparator OP outputs a high level signal to turn on the controllable switch Q1.

This is a specific circuit structure of the monitoring module. Because the primary coil and the secondary coil of the transformer TR1 are separated, a main circuit of the primary coil and a sampling circuit of the secondary coil do not affect each other. If the circuit on either side of the transformer TR1 has any problems, the circuit on the other side is not damaged, and reliability is high. In addition, because current in the secondary coil of the transformer TR1 is proportional to current in the primary coil of the transformer, the sampling voltage on two ends of the divider resistor R1 connected with the secondary coil may linearly change along with the current of the primary coil, thus, change of the current is converted into change of voltage, which favoringly controls collection of current data. The technical scheme of using the comparator OP is simple and lower in cost. When the voltage at the non-inverting input is greater than the voltage at the inverting input, the high level signal is outputted. It should be understood that if the controllable switch Q1 is turned on by a low level signal, a comparator OP with opposite logic may be used.

If the preset value is zero, the inductor L1 has no output current and the current flowing through the transformer TR1 is zero. Thus, the secondary coil has no current, and the sampling voltage is zero. Voltage difference between the sampling voltage and the reference voltage may be further increased. A logical determination of the comparator OP is more accurate, thus avoiding resulting in misoperation caused by smaller voltage difference.

The present disclosure is described in detail in accordance with the above contents with the specific preferred examples. However, this present disclosure is not limited to the specific examples. For the ordinary technical personnel of the technical field of the present disclosure, on the premise of keeping the conception of the present disclosure, the technical personnel can also make simple deductions or replacements, and all of which should he considered to belong to the protection scope of the present disclosure.

We claim:

1. A backlight driving circuit, comprising:
a power supply module;
an inductor connected with an output end of the power supply module; and
a light emitting diode (LED) lightbar connected with the inductor in series;
wherein a monitoring module detecting an output current of the inductor is coupled between the inductor and the LED lightbar, and a controllable switch is connected between an output end of the inductor and a grounding terminal of the backlight driving circuit; wherein the monitoring module is coupled with the controllable switch, and when the output current of the inductor is lower than a preset value, the monitoring module controls the controllable switch to turn on.

2. The backlight driving circuit of claim 1, wherein the monitoring module comprises a current detecting unit connected between the inductor and the lightbar in series, and a control unit coupled with the current detecting unit; a control signal of the control unit is coupled to the controllable switch.

3. The backlight driving circuit of claim 2, wherein the current detecting unit comprises a transformer, a primary coil of the transformer is connected between the inductor and the lightbar in series, and a secondary coil of the transformer is grounded by a divider resistor; a comparison voltage of the divider resistor is coupled to the control unit.

4. The backlight driving circuit of claim 2, wherein the control unit comprises a comparator, a non-inverting input of the comparator is coupled with a reference voltage, the current detecting unit outputs a comparison voltage to an inverting input of the comparator; when the output current of the inductor is lower than the preset value, if the reference voltage is greater than the comparison voltage, the reference voltage becomes less than the comparison voltage, and if the comparison voltage is greater than the reference voltage, then the comparison voltage becomes less than the reference voltage, which enables the comparator to output a control signal to turn on the controllable switch.

5. The backlight driving circuit of claim 4, wherein when the comparison voltage is lower than the reference voltage, the comparator outputs a high level signal to turn on the controllable switch.

6. The backlight driving circuit of claim 1, wherein the preset value is zero.

7. The backlight driving circuit of claim 1, wherein the preset value is zero; the monitoring module comprises a current detecting unit connected between the inductor and the lightbar in series, and a control unit coupled with the current detecting unit, a control signal of the control unit is coupled to the controllable switch; wherein the current detecting unit comprises a transformer, a primary coil of the transformer is connected between the inductor and the lightbar in series, and a secondary coil of the transformer is grounded by a divider resistor; wherein the control unit comprises a comparator, a non-inverting input of the comparator is coupled with a reference voltage, an output of the comparator is coupled to the controllable switch; wherein a comparison voltage of the divider resistor is coupled to an inverting input of the comparator, when the output current of the inductor is zero, the comparison voltage is lower than the reference voltage, the comparator outputs a control signal to turn on the controllable switch.

8. The backlight driving circuit of claim 1, wherein a diode is connected between the inductor and the monitoring module in series; an anode of the diode is coupled to the inductor, and a cathode of the diode is coupled to the monitoring module; a capacitor is connected to two ends of the lightbar in parallel.

9. A backlight module, comprising:
a backlight driving circuit;
wherein the backlight driving circuit comprises a power supply module, an inductor connected with an output end of the power supply module, and a light emitting diode (LED) lightbar connected with the inductor in series; a monitoring nodule detecting an output current of the inductor is coupled between the inductor and the LED lightbar, and a controllable switch is connected between an output end of the inductor and a grounding terminal of the backlight driving circuit; wherein the monitoring module is coupled with the o controllable switch, when the output current of the inductor is lower than a preset value, the monitoring module controls the controllable switch to turn on.

10. The backlight module of claim 9, wherein the monitoring module comprises a current detecting unit connected between the inductor and the lightbar in series, and a control unit coupled with the current detecting unit; a control signal of the control unit is coupled to the controllable switch.

11. The backlight module of claim 10, wherein the current detecting unit comprises a transformer; a primary coil of the transformer is connected between the inductor and the lightbar in series, and a secondary coil of the transformer is grounded by a divider resistor; a comparison voltage of the divider resistor is coupled to the control unit.

12. The backlight module of claim 10, wherein the control unit comprises a comparator a non-inverting input of the comparator is coupled with a reference voltage, the current detecting unit outputs a comparison voltage to an inverting input of the comparator; when the output current of the inductor is lower than the preset value, if the reference voltage is greater than the comparison voltage, the reference voltage becomes less than the comparison voltage, and if the comparison voltage is greater than the reference voltage, then the comparison voltage becomes less than the reference voltage, which enables the comparator to output a control signal to turn on the controllable switch.

13. The backlight module of claim 12, wherein when the comparison voltage is lower than the reference voltage, the comparator outputs a high level signal to turn on the controllable switch.

14. The backlight module of claim 9, wherein the preset value is zero.

15. The backlight module of claim 9, wherein the preset value is zero: the monitoring module comprises a current detecting unit connected between the inductor and the lightbar in series, and a control unit coupled with the current detecting unit, a control signal of the control unit is coupled to the controllable switch; wherein the current detecting unit comprises a transformer, a primary coil of the transformer is connected between the inductor and the lightbar in series, and a secondary coil of the transformer is grounded by a divider resistor; wherein the control unit comprises a comparator, a non-inverting input of the comparator is coupled with a reference voltage, an output of the comparator is coupled to the controllable switch; wherein a comparison voltage of the divider resistor is coupled to an inverting input of the comparator, when the output current of the inductor is zero, the comparison voltage is lower than the reference voltage, the comparator outputs a control signal to turn on the controllable switch.

16. The backlight module of claim 9, wherein a diode is connected between the inductor and the monitoring module in series; an anode of the diode is coupled to the inductor, and a cathode of the diode is coupled to the monitoring module; a capacitor is connected to two ends of the lightbar in parallel.

17. A liquid crystal display (LCD) device, comprising:
a backlight module comprising a backlight driving circuit;
wherein the backlight driving circuit comprises a power supply module, an inductor connected with an output end of the power supply module, and a light emitting diode (LED) lightbar connected with the inductor in series; a monitoring module detecting an output current of the inductor is coupled between the inductor and the LED lightbar, and a controllable switch is connected between an output end of the inductor and a grounding terminal of the backlight driving circuit; wherein the monitoring module is coupled with the controllable switch, when the output current of the inductor is lower than a preset value, the monitoring module controls the controllable switch to turn on.
